(19) United States
(12) Patent Application Publication
(10) Pub. No.: US 2015/0181372 A1
(43) Pub. Date: Jun. 25, 2015

(54) Location Accuracy Prediction

(71) Applicant: Apple Inc., Cupertino, CA (US)

(72) Inventors: Joseph Ding-Jiu Huang, Kingston (CA); Ronald K. Huang, San Jose, CA (US); Robert Mayor, Half Moon Bay, CA (US); David Benjamin Millman, Mountain View, CA (US)

(73) Assignee: Apple Inc., Cupertino, CA (US)

(21) Appl. No.: 14/137,977

(22) Filed: Dec. 20, 2013

(51) Int. Cl. H04W 4/02

(52) U.S. Cl. CPC H04W 4/02

(57) ABSTRACT

Survey data for an environment is used to predict the accuracy of a position estimate in the environment and whether or not more survey data may improve that accuracy. In some implementations, a user performs a site survey of an environment by observing the strengths of radio frequency signals at various survey points in the environment. An expected positioning accuracy of the surveyed environment can be determined using the new survey data collected and optionally historical survey data for the environment. The user can be informed about the usefulness of collecting additional survey data and/or the expected positioning accuracy in the environment.

### TECHNICAL FIELD

This disclosure relates generally to network-based or beacon-based positioning systems and methods.

### BACKGROUND

Many modern mobile devices (e.g., a smart phone, e-tablet, wearable devices) include a navigation system. The navigation system can include a microprocessor that executes a software navigation application that uses data from one or more inertial sensors (e.g., accelerometer, gyro, magnetometer) and position coordinates from a positioning system (e.g., satellite-based, network-based) to determine the current location and direction of travel of the mobile device. The navigation application allows a user to input a desired destination and calculate a route from the current location to the destination according to the user's preferences. A map display includes markers to show the current location of the mobile device, the desired destination and points of interest (POIs) along the route. Some navigation applications can provide a user with turn-by-turn directions. The directions can be presented to the user on the map display and/or by a navigation assistant through audio output. Other mobile device applications may use location for personalization and context.

Satellite-based positioning systems typically cannot provide a position estimate for indoor navigation because satellite signals may not be received indoors. For indoor navigation, network-based positioning systems are often used. An example network-based positioning system is system that relies on radio frequency signal strengths to estimate a position of a mobile device.

### SUMMARY

Survey data for an environment (e.g., indoor space) is used to predict the accuracy of a position estimate in the environment and whether or not more survey data may improve that accuracy. In some implementations, a user performs a site survey of the environment by observing the strengths of radio frequency (RF) signals (e.g., Wi-Fi signals) at various survey points in the environment. The RF signals can be transmitted by access points or beacons at fixed locations in the environment, which can be detected in a scan (e.g., Wi-Fi scan) by a mobile device held by the user. An expected positioning accuracy of the surveyed environment can be determined using the new survey data collected and optionally historical survey data for the environment. The user can be informed about the usefulness of collecting additional survey data and/or the expected positioning accuracy in the environment. For example, visual (e.g., using a map display) or audio feedback can be provided to a surveyor while the environment is being surveyed.

In some implementations, a method of determining a grid-cell size for estimating the location of a device operating in an environment having radio frequency (RF) signal sources comprises: dividing the environment into a grid including a number of grid-cells, each grid-cell having a first grid-cell size; for each grid-cell containing one or more survey points: determining a likelihood score based on a signal strength measured at the one or more survey points; contributing the signal strength measurement to a statistical model for the grid-cell, where the statistical model provides a total likelihood score for the grid-cell; determining a total likelihood score for the grid from the total likelihood scores for the surveyed grid-cells; and repeating the method for one or more additional grids, each additional grid including grid-cells having grid-cell sizes that are different than the first grid-cell size.

Other implementations are directed to devices and computer-readable mediums. Particular implementations disclosed herein provide one or more of the following advantages. A surveyor can collect survey data in an environment in real-time using a mobile device and the device can advise (e.g., visually, through audio or force feedback) the surveyor whether or not to continue surveying and/or an expected positioning accuracy for the environment. Likewise, venue operators and other site managers can be informed by a survey application about locations in a venue that might benefit from additional signal coverage by relocating or adding RF signal sources at the location.

The details of the disclosed implementations are set forth in the accompanying drawings and the description below. Other features, objects and advantages are apparent from the description, drawings and claims.

### DESCRIPTION OF DRAWINGS

FIG. 1A is a floor plan for an example environment showing a first scan location in grid-cell 4.

FIG. 1B is a graph of a likelihood score for the first scan location in grid-cell 4.

FIG. 2 is a graph of a probability density function for the first scan location in grid-cell 4.

FIG. 3A is a floor plan for the example environment showing a second scan location in grid-cell 4.

FIG. 3B is a graph of an example likelihood score for the second scan location in grid-cell 4.

FIG. 4 is a graph of probability density function for the second scan location in grid-cell 4.

FIG. 5A is a floor plan for an example environment showing a third scan location in grid-cell 4.

FIG. 5B is a graph of a likelihood score for the third scan location in grid-cell 4.

FIG. 6 is a graph of a probability density function of the third scan location in grid-cell 4.

FIG. 7A is a floor plan for an example environment showing a first scan location in grid-cell 13.

FIG. 7B is a graph of a likelihood score for the first scan location in grid-cell 13.

FIG. 8 is a graph of a probability density function for the first scan location in grid-cell 13.

FIG. 9A is a floor plan for an example environment showing a second scan location in grid-cell 13.

FIG. 9B is a graph of a likelihood score for the second scan location in grid-cell 13.

FIG. 10A is a floor plan for an example environment showing first scan location in grid-cell 14

FIG. 10B is a graph of a likelihood score for the first scan location in grid-cell 14.

FIG. 11 is a graph of a probability density function for the first scan location in grid-cell 14.

FIG. 12A is a floor plan for an example environment showing a second scan location in grid-cell 14.

FIG. 12B is a graph of a likelihood score for the second location in grid-cell 14.

FIG. 13 is a graph illustrating total likelihood score as a function of grid cell size.

FIG. 14 is a flow diagram of an example process for determining likelihood scores for grid-cells using survey data.

FIG. 15 is a block diagram of example device architecture for implementing the features and processes described in reference to FIGS. 1-14.

FIG. 16 is a block diagram of an example operating environment for devices having the architecture shown in FIG. 15.

The same reference symbol used in various drawings indicates like elements.

### DETAILED DESCRIPTION

### Example System

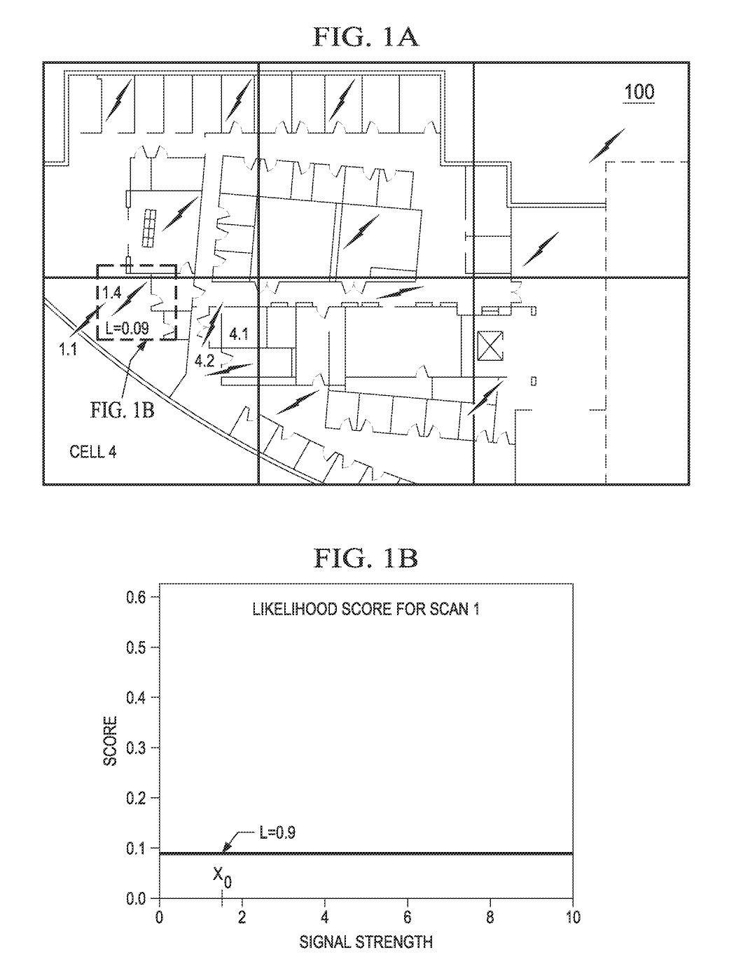

FIGS. 1-13 illustrate an example system for determining likelihood scores for grid-cells using survey data. In some implementations, the system can be a survey application running on a mobile device (e.g., handheld or wearable device). A user can walk through environment 100 (e.g., indoor environment) with the mobile device. At given survey points of environment 100, an RF receiver in the mobile device can scan for RF signal sources. In some implementations, an RF signal source can be a Wi-Fi access point (AP) or beacon (e.g., Bluetooth low energy beacon).

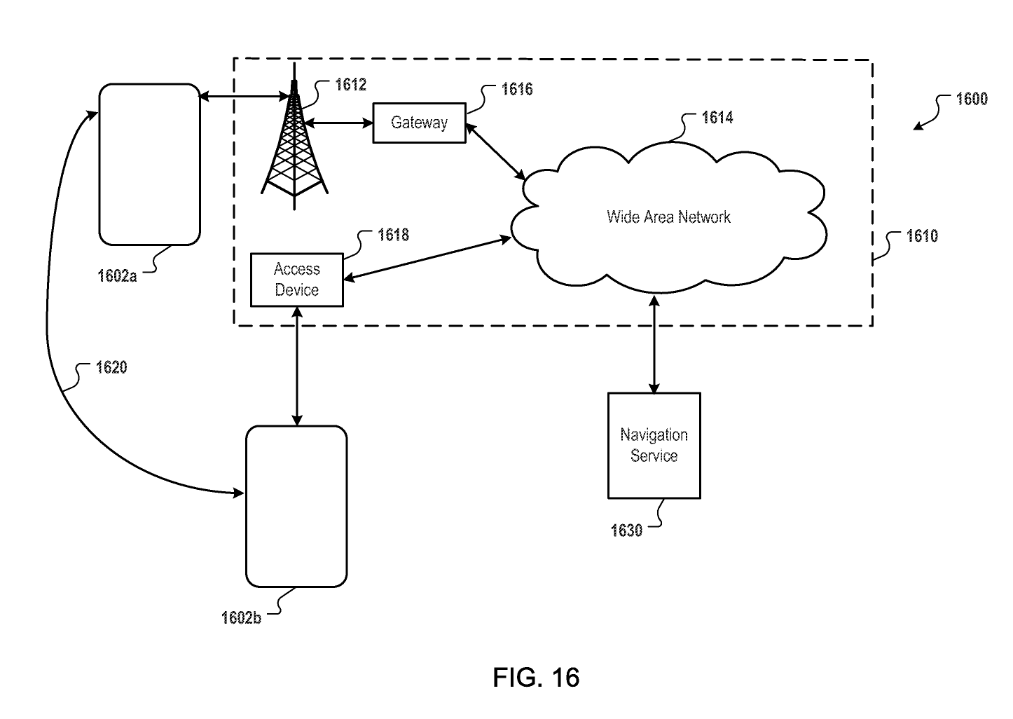

Each scan has a location and signal strength. The location can be represented by latitude, longitude and height or as vector in a desired geographic coordinate system. An example metric for signal strength can be a received signal strength indicator (RSSI), which is a measurement of the power present in a received RF signal. The scan results can be processed by one or more processors of the mobile device or transmitted to another device (e.g., a network server) for further processing, as described in reference to FIG. 16.

Referring now to FIG. 1A, a number of APs (e.g., Wi-Fi APs) are shown distributed about environment 100. In the example shown, there are 14 APs. Environment 100 is initially divided (conceptually) into a number of N×N grid-cells (e.g., N=8 meters). In the example shown, there are six grid-cells. For discussion purposes, the cells are numbered 1-6 starting from the top left corner and moving from left to right and top to bottom. Although the grid-cells are square-shaped in this example, grid-cells can be any desired shape and size (e.g., based on a floor plan of the environment).

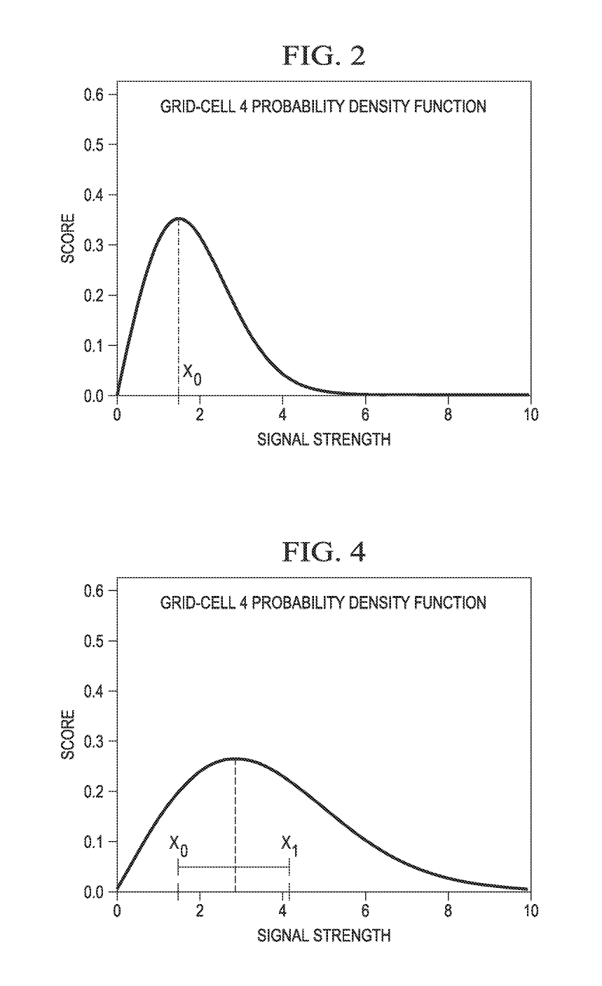

Referring to Cell 4, a first survey point is selected and is indicated by a circle. In this example, the first survey point is AP #1. When the user is standing near the AP #1, a first scan shows signal strength X₀=1.4. A likelihood score L can be calculated for the signal strength, as shown in FIG. 1B. In this example, L=0.09. After the score is calculated, the score is added to a probability distribution for Cell 4, as shown in FIG. 2. Because no scans were previously made for Cell 4, the likelihood score is uniform across a range of signal strengths, as shown in FIG. 1B. A uniform likelihood score distribution across a range of signal strengths is an example of a type of scoring that can be used if no scans were previously made for a cell. Another example is an exponential likelihood score distribution. In this example the first survey point is the first survey point chronologically. However, any fixed ordering of survey points can be used. In some implementations, survey points can be purposefully re-ordered or shuffled to provide a more robust process. In general, different orderings of survey points will produce better results, and looking at several orderings in aggregate may produce better results overall.

The likelihood score for the signal strength measurement can be calculated using a statistical model, such as a likelihood function or log-likelihood function (to simplify the mathematics by replacing products with additions). The probability distribution for the grid-cell can be, for example, a Rayleigh distribution, which can be approximated from a histogram of likelihood values as a function of signal strengths. Other distributions include Gaussian, Ricean and lognormal distributions. A Ricean distribution describes wireless transmission indoors and a lognormal distribution describes wireless transmission outdoors.

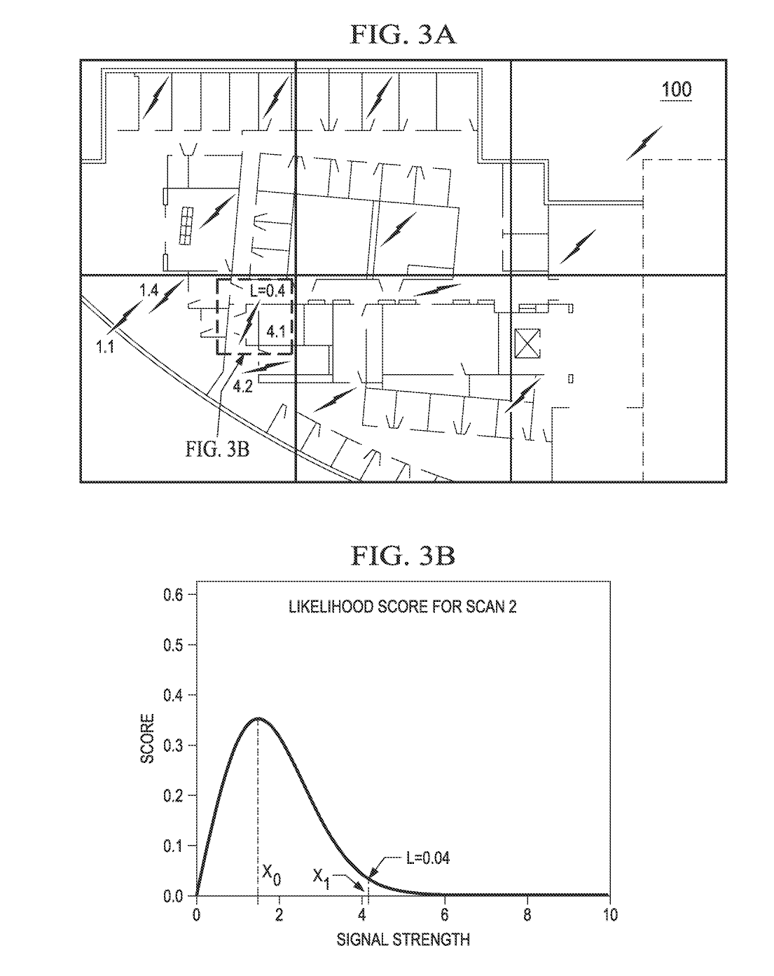

Referring to FIG. 3A, a second scan is performed at a second survey point in Cell 4 and a second signal strength X₁ is obtained. The second survey point is AP #2. The likelihood score is L=0.04, as shown in FIG. 3B. FIG. 4 shows the contribution of the signal strengths X₀, X₁ to the probability distribution for Cell 4.

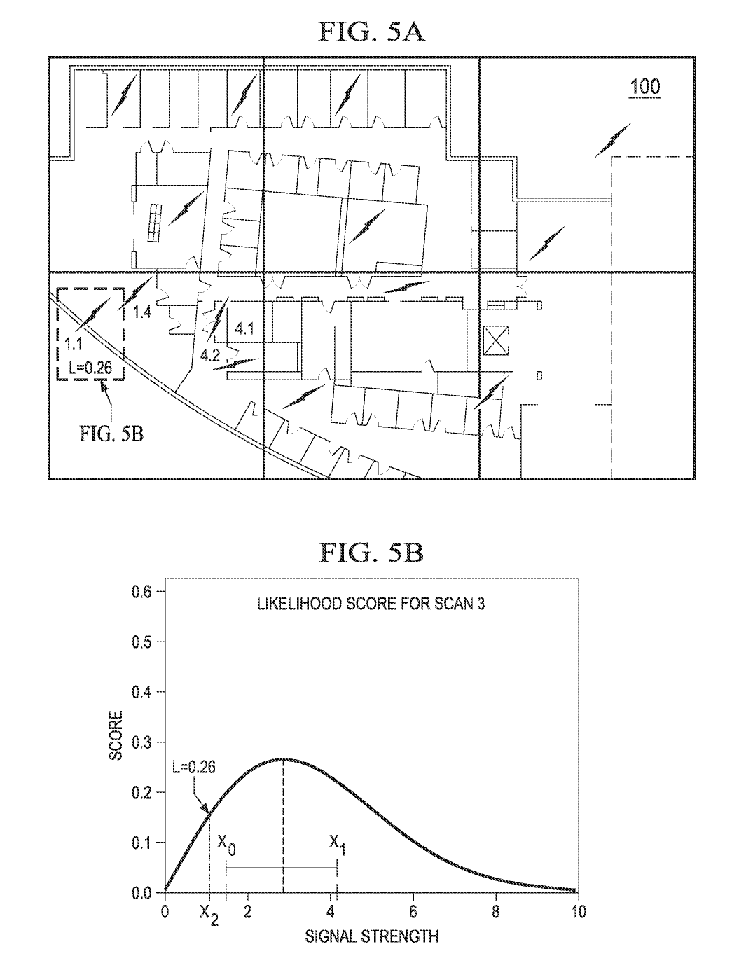

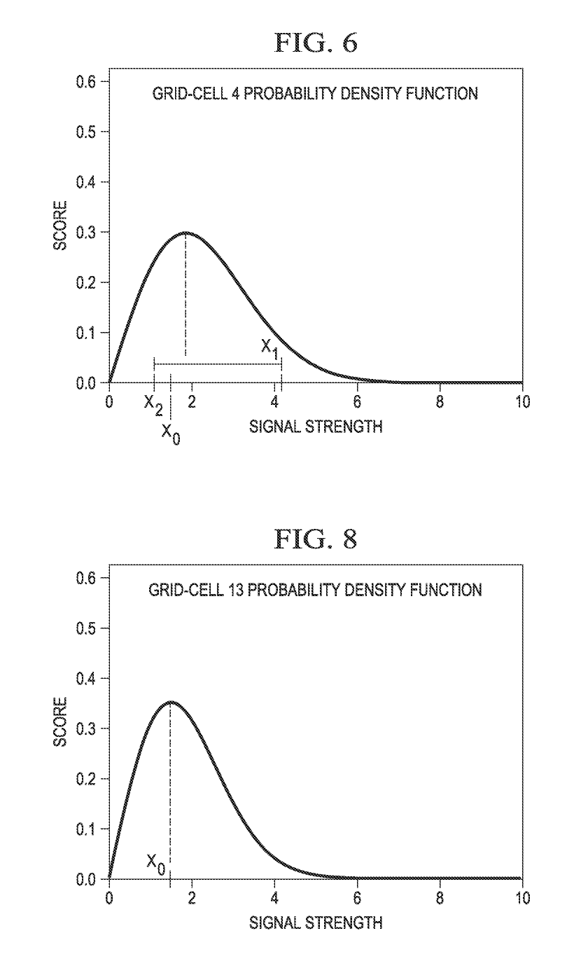

Referring to FIG. 5A, a third scan is performed at a third survey point and a third signal strength X₂ is obtained. The third survey point is AP #3. The likelihood score is L=0.26, as shown in FIG. 5B. FIG. 6 shows the contribution of the signal strengths X₀, X₁, X₂ to the probability distribution of Cell 4.

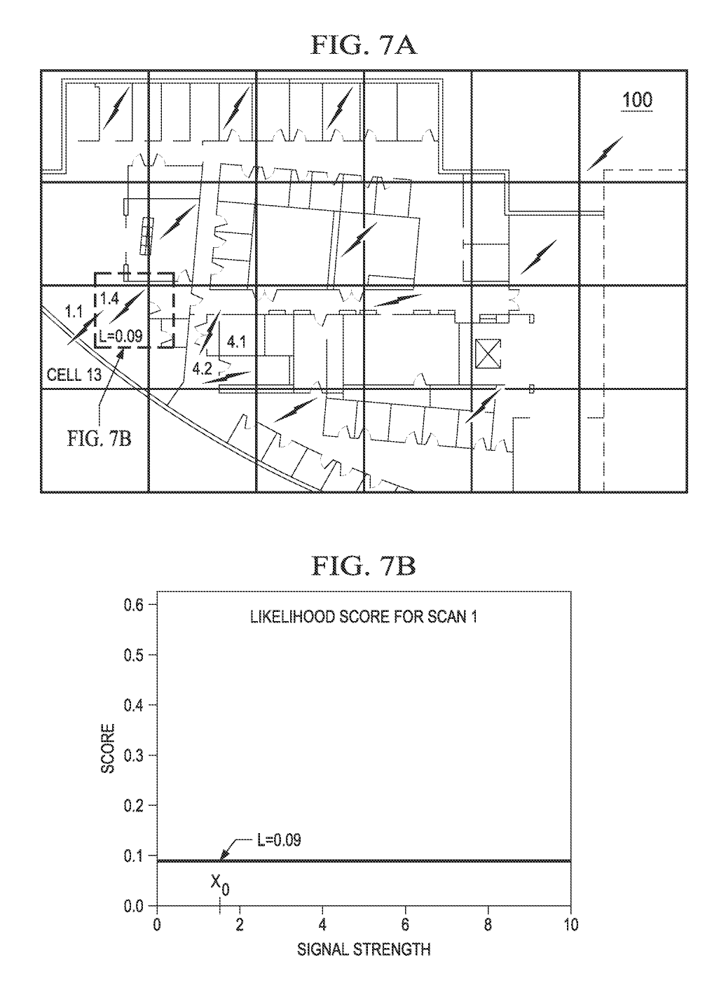

The process described above is repeated for AP #4 and any other desired survey points in Cell 4. A total likelihood score is computed for Cell 4 by adding log likelihood scores determined for the desired survey points in Cell 4. The process is then repeated for grid-cells 1-3, 5 and 6 and the total log likelihood scores for all the grid-cells 1-6 are added together, resulting in a total log likelihood score for the grid size of N=8 meters. The grid-cell size can then be changed (e.g., reduced to 6 meters) and the process repeated, as described below in reference to FIGS. 7-13. In the example shown, all the grid cells have the same size. However, in other implementations several different grid-cell sizes can be used simultaneously, especially if the cells are not square-shaped.

Referring to FIG. 7A, the process is repeated for a smaller grid-cell size (e.g., N=6 meters). In the example shown, environment 100 is divided into 24 cells. A first scan is performed at a first survey point in Cell 13 to obtain signal strength X₀. The first survey point is AP #1. The likelihood score is L=0.09. Since no scans have been incorporated in the probability distribution for Cell 13 (as in this example), the likelihood score is uniform across the range of signal strengths, as shown in FIG. 7B. FIG. 8 shows the contribution of the signal strength X₀ to the probability distribution of Cell 13.

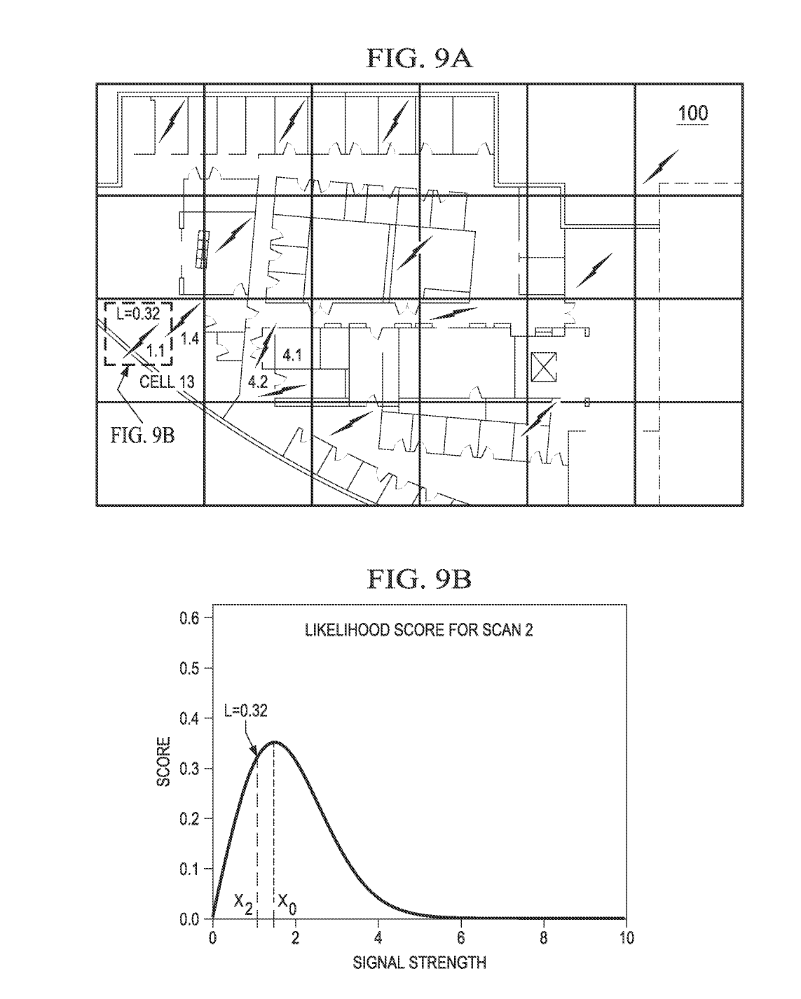

Referring to FIG. 9A, a second scan is performed at a second survey point in Cell 13 to obtain a signal strength X₁. The second survey point is AP #3. The likelihood score is L=0.32, as shown in FIG. 9B. This time the likelihood is higher because other survey points in Cell 13 all have similar signal strengths. The likelihood scores for signal strengths X₀, X₁ are contributed to a probability distribution for Cell 13 (not shown). Since there are no more survey points in Cell 13, the process is applied to the next grid-cell in the grid (e.g., Cell 14).

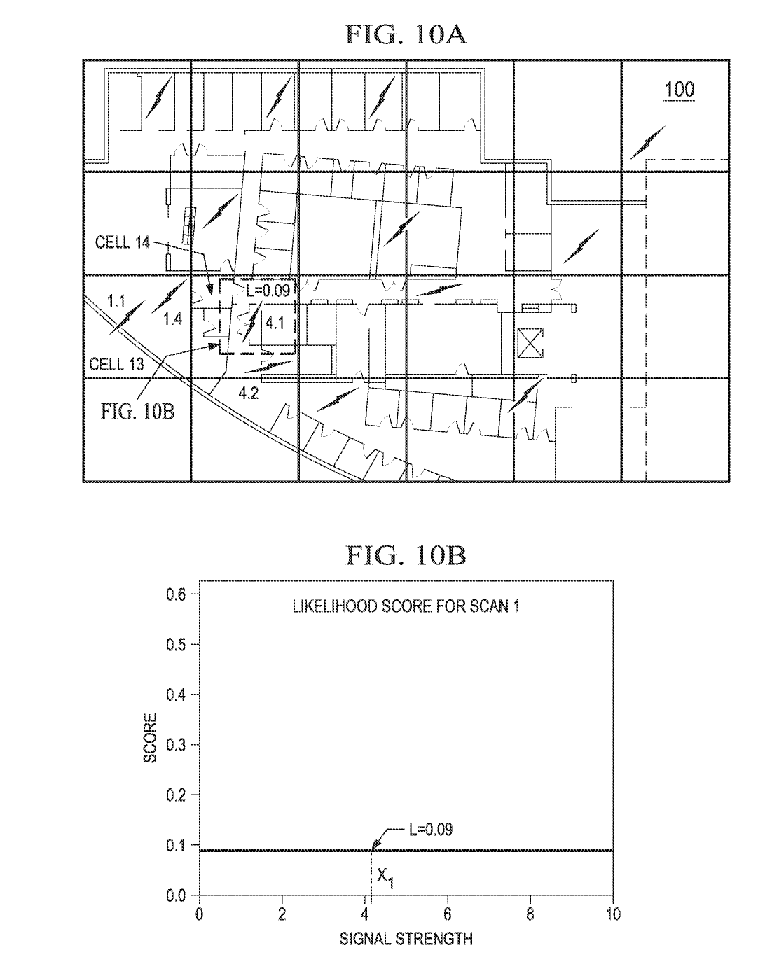

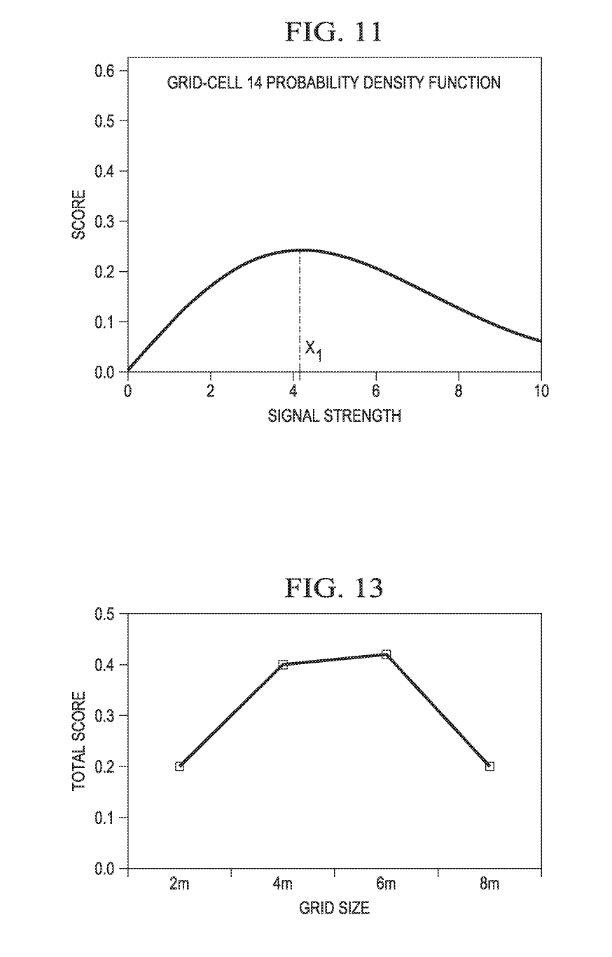

Referring to FIG. 10A, a first scan is performed at a first survey point in Cell 14; a new grid-cell. The second survey point is AP #2. The likelihood score L=0.09. Since no scans have been incorporated in the cell probability distribution (as in this example), the likelihood score is uniform across the range of signal strengths, as shown in FIG. 10B. FIG. 11 shows the contribution of signal strength X₁ to the probability distribution of Cell 14. Because this is a new grid-cell, this is the first signal strength to be contributed to the probability distribution for Cell 14.

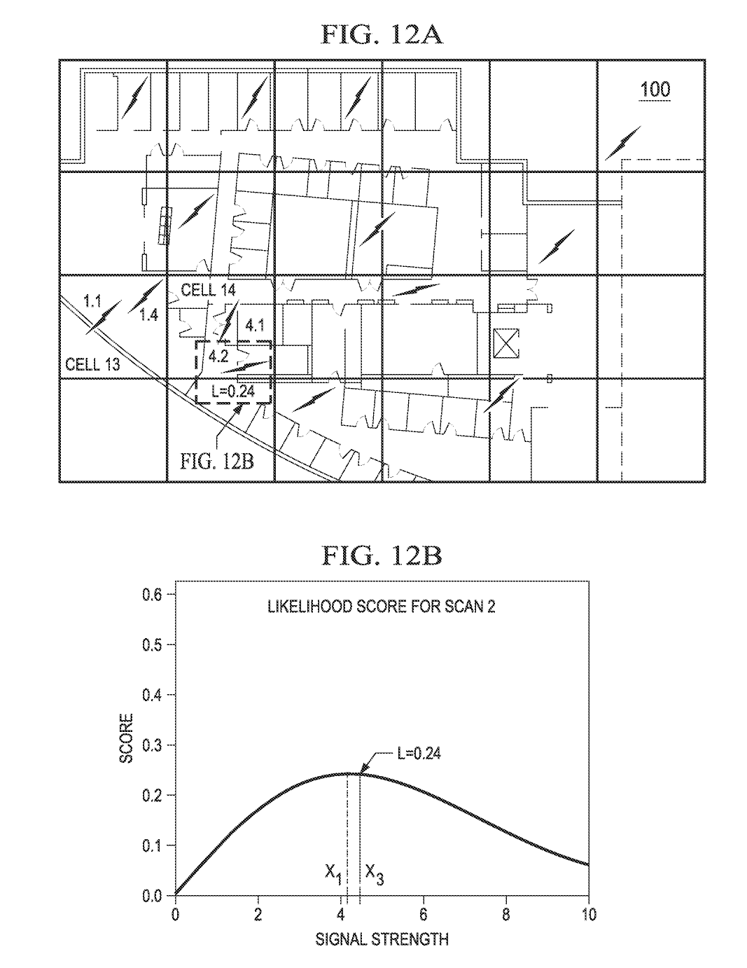

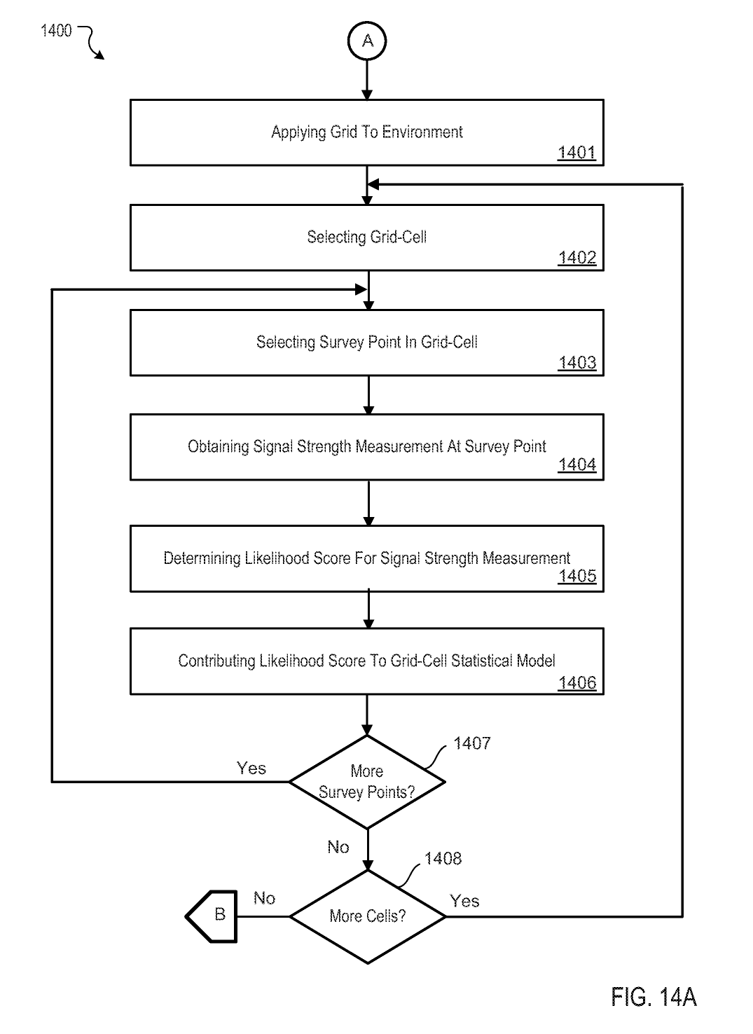

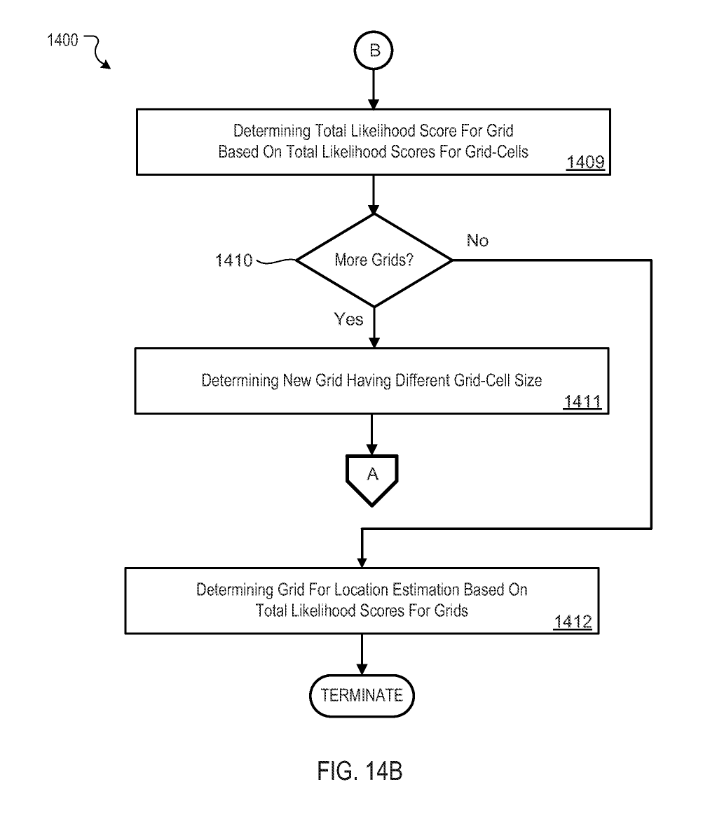

Referring to FIG. 12A, a second scan is performed at a second survey point in Cell 14 to obtain a signal strength X₃. The second survey point is AP #4. The likelihood score is L=0.24, as shown in FIG. 12B. Since there are no more survey points in Cell 14, the process is applied to the next grid-cell in the grid (e.g., Cell 15).

The process is repeated for all cells in the grid and the total log likelihood scores for all the cells in the grid are added together to get a total log likelihood score for the grid size of N=6 meters.

FIG. 13 is plot of total likelihood score versus grid-cell size. In the plot shown, the process described above was performed for 4 different grid-cell sizes: 3 meters, 4 meters, 6 meters and 8 meters. As can be observed from the plot, finding the optimal grid size has been reduced to a one-dimensional (1D) local optimum search. Any known optimum search technique can be used to find the optimum grid size, including but not limited to: Golden Section Search, BOBYQA and Multilevel Coordinate Search.

It is noted that reducing the grid-cell size does improve the total likelihood score because near-by scans at the grid-cell size have locally consistent signal strengths. However, if we shrink the grid-cell size further, total likelihood score drops because too many survey points have a likelihood score that is uniform over a range of signal strengths. In this example, the plot shows that selecting a grid-cell size less than 4 meters or greater than 6 meters does not result in a higher likelihood score for the grid.

### Example Process

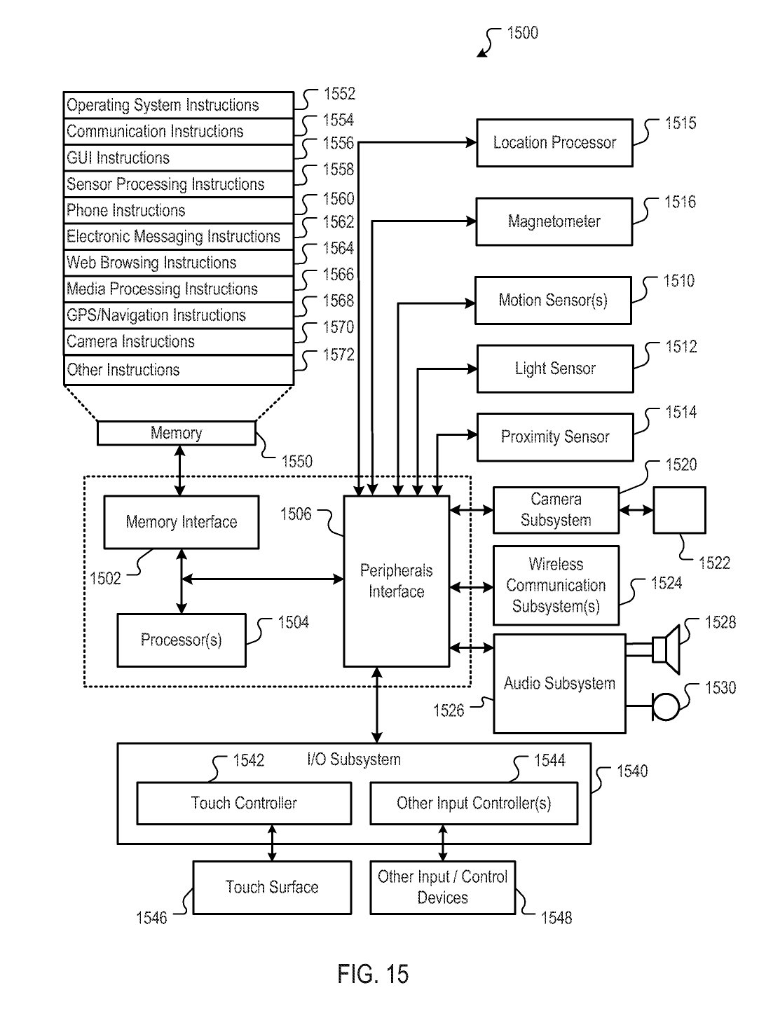

FIG. 14 is a flow diagram of an example process 1400 for determining likelihood scores for grid-cells using survey data. Process 1400 can be implemented by device architecture 1500, as described in reference to FIG. 15.

In some implementations, process 1400 can begin by applying a grid to an environment having multiple RF signal sources (1401). RF signal sources can be Wi-Fi APs or any other wireless technology that provides RF signals that can be used for position estimation. The grid can be any shape or size.

Process 1400 can continue by, selecting a grid-cell (1402) and selecting a survey point in the selected grid-cell (1403). The grid-cells can be selected for processing in any desired order. A survey point can be an AP or any other desired location in the environment.

Process 1400 can continue by obtaining a signal strength measurement from a scan at the survey point (1404). Signal strength can be measured using any known methods. In some implementations, RSSI values can be used to measure signal strength.

Process 1400 can continue by determining a likelihood score for the strength measurement (1405) and contributing the score to a statistical model for the grid-cell (1406). The likelihood score can be any suitable likelihood function a including a log-likelihood function to simplify the mathematics by performing additions of probabilities rather than products of probabilities. The statistical model provides a total likelihood score for the grid-cell based on the signal strength measurements obtained from the survey points in the grid-cell. An example statistical model is a Rayleigh distribution. The Rayleigh distribution can be approximated using a histogram to get a best-fit Rayleigh distribution.

If there are more survey points in the grid-cell (1407), process 1400 repeats steps 1403-1406 until there are no survey points remaining in the grid-cell to process. If there are no remaining survey points to be processed, and if there are more grid-cells in the grid to process (1408), then steps 1402-1407 of process 1400 are repeated for the remaining grid-cells.

If there are no more grid-cells in the grid, then process 1400 determines the total likelihood score for the grid (1409). If there are more grids to process (1410), a new grid having a different grid-cell size is determined (1411), and steps 1401-1409 of process 1400 are repeated using the new grid. If there are no more grids to be processed, a grid for location estimation is determined based on the total likelihood scores for the grids (1412) and the process terminates.

### Example Equations

The likelihood of a given signal-strength measurement x being observed by a mobile device scan, given a particular grid size θ, can be represented mathematically by

L(θ|x)=Pr(x|θ). [1]

For a set of signal strength measurements we have

L(θ|xᵢ)=Pr{x₀|θ}Pr{x₁|x₀,θ}Pr{x₂|x₀,x₁,θ} . . . Pr{x_{N}| . . . , x₂,x₁,x₀,θ}, [2]

where xᵢ denotes a signal-measurement and equation [2] is the product of the likelihoods of each signal-strength measurement xᵢ given that only its earlier observation had a particular set of observed values. The best-fitting grid-cell size for location estimation can be then be determined by

argmax{θ}L(θ|xᵢ), [3]

which means as the position estimation algorithm improves in the future, the grid size detection will automatically improve as well. The computation of equation [3] can be simplified by

argmax{θ} log(L(θ|xᵢ)), [4]

where [4] converts the product of likelihoods into a sum of log likelihoods.

Any known algorithm that searches for the minimum value of a function ƒ(θ) can be used to determine the best grid-cell size for location estimation, where ƒ( ) is L(θ|xᵢ) and θ is the grid-cell size. Some examples of search algorithms include but are not limited to: Golden Section Search, BOBYQA and Multilevel Coordinate Search.

### Example Pseudocode

The following commented pseudocode further illustrates process 1400.

### DEFINITIONS

```
build_radio_map (historical_scan_data); //This function builds a radio map from
historical scan data (e.g., Wi-Fi scan data) on a cell-by-cell basis. In some
implementations, a best-fit Rayleigh distribution is determined by this function for a
given cell//
measure_against_radio_map (scan_data, radio_map_cell); //This function computes the
likelihood of a given scan being observed at a given grid-cell of the radio map//
likelihood_of_grid_size (grid_size);
for each survey_point (e.g., survey_point);
  create grid with size grid_size; //assumes that survey_point is only survey point in
grid-cell//
  for each grid_cell;
    grid_cell =build_radio_map ( ); //assumes no historical scan data//
      for each scan;
        likelihood = measure_against_radio_map (scan_data, grid_cell);
        grid_cell = build_radio_map (scan data); //This code replaces the existing
grid_cell at the survey point. This step can also be done incrementally by taking the
existing radio_map grid_cell result and performing a small incremental calculation to
get an updated grid_cell without re-calculating all scan data obtained so far//
  log total_likelihood = total_likelihood + likelihood; //add log likelihood into total
likelihood//
return log total_likelihood
```

### Example Mobile Device Architecture

FIG. 15 is a block diagram of example device architecture 1500 for implementing the features and processes described in reference to FIGS. 1-14.

Architecture 1500 may be implemented in any device for generating the features described in reference to FIGS. 1-14, including but not limited to portable or desktop computers, smart phones and electronic tablets, television systems, game consoles, kiosks, wearable devices and the like. Architecture 1500 may include memory interface 1502, data processor(s), image processor(s) or central processing unit(s) 1504, and peripherals interface 1506. Memory interface 1502, processor(s) 1504 or peripherals interface 1506 may be separate components or may be integrated in one or more integrated circuits. One or more communication buses or signal lines may couple the various components.

Sensors, devices, and subsystems may be coupled to peripherals interface 1506 to facilitate multiple functionalities. For example, motion sensor 1510, light sensor 1512, and proximity sensor 1514 may be coupled to peripherals interface 1506 to facilitate orientation, lighting, and proximity functions of the device. For example, in some implementations, light sensor 1512 may be utilized to facilitate adjusting the brightness of touch surface 1546. In some implementations, motion sensor 1510 (e.g., an accelerometer, gyros) may be utilized to detect movement and orientation of the device. Accordingly, display objects or media may be presented according to a detected orientation (e.g., portrait or landscape).

Other sensors may also be connected to peripherals interface 1506, such as a temperature sensor, a biometric sensor, or other sensing device, to facilitate related functionalities.

Location processor 1515 (e.g., GPS receiver) may be connected to peripherals interface 1506 to provide geo-positioning. Electronic magnetometer 1516 (e.g., an integrated circuit chip) may also be connected to peripherals interface 1506 to provide data that may be used to determine the direction of magnetic North. Thus, electronic magnetometer 1516 may be used as an electronic compass.

Camera subsystem 1520 and an optical sensor 1522, e.g., a charged coupled device (CCD) or a complementary metal-oxide semiconductor (CMOS) optical sensor, may be utilized to facilitate camera functions, such as recording photographs and video clips.

Communication functions may be facilitated through one or more communication subsystems 1524. Communication subsystem(s) 1524 may include one or more wireless communication subsystems. Wireless communication subsystems 1524 may include radio frequency receivers and transmitters and/or optical (e.g., infrared) receivers and transmitters. Wired communication system may include a port device, e.g., a Universal Serial Bus (USB) port or some other wired port connection that may be used to establish a wired connection to other computing devices, such as other communication devices, network access devices, a personal computer, a printer, a display screen, or other processing devices capable of receiving or transmitting data.

The specific design and implementation of the communication subsystem 1524 may depend on the communication network(s) or medium(s) over which the device is intended to operate. For example, a device may include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, and a Bluetooth™ network. Communication subsystems 1524 may include hosting protocols such that the device may be configured as a base station for other wireless devices. As another example, the communication subsystems may allow the device to synchronize with a host device using one or more protocols, such as, for example, the TCP/IP protocol, HTTP protocol, UDP protocol, and any other known protocol.

Audio subsystem 1526 may be coupled to a speaker 1528 and one or more microphones 1530 to facilitate voice-enabled functions, such as voice recognition, voice replication, digital recording, and telephony functions.

I/O subsystem 1540 may include touch controller 1542 and/or other input controller(s) 1544. Touch controller 1542 may be coupled to a touch surface 1546. Touch surface 1546 and touch controller 1542 may, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch surface 1546. In one implementation, touch surface 1546 may display virtual or soft buttons and a virtual keyboard, which may be used as an input/output device by the user.

Other input controller(s) 1544 may be coupled to other input/control devices 1548, such as one or more buttons, rocker switches, thumb-wheel, infrared port, USB port, and/or a pointer device such as a stylus. The one or more buttons (not shown) may include an up/down button for volume control of speaker 1528 and/or microphone 1530.

In some implementations, device 1500 may present recorded audio and/or video files, such as MP3, AAC, and MPEG files. In some implementations, device 1500 may include the functionality of an MP3 player and may include a pin connector for tethering to other devices. Other input/output and control devices may be used.

Memory interface 1502 may be coupled to memory 1550. Memory 1550 may include high-speed random access memory or non-volatile memory, such as one or more magnetic disk storage devices, one or more optical storage devices, or flash memory (e.g., NAND, NOR). Memory 1550 may store operating system 1552, such as Darwin, RTXC, LINUX, UNIX, OS X, WINDOWS, or an embedded operating system such as VxWorks. Operating system 1552 may include instructions for handling basic system services and for performing hardware dependent tasks. In some implementations, operating system 1552 may include a kernel (e.g., UNIX kernel).

Memory 1550 may also store communication instructions 1554 to facilitate communicating with one or more additional devices, one or more computers or servers. Communication instructions 1554 may also be used to select an operational mode or communication medium for use by the device, based on a geographic location (obtained by the GPS/Navigation instructions 1568) of the device. Memory 1550 may include graphical user interface instructions 1556 to facilitate graphic user interface processing, including a touch model for interpreting touch inputs and gestures; sensor processing instructions 1558 to facilitate sensor-related processing and functions; phone instructions 1560 to facilitate phone-related processes and functions; electronic messaging instructions 1562 to facilitate electronic-messaging related processes and functions; web browsing instructions 1564 to facilitate web browsing-related processes and functions; media processing instructions 1566 to facilitate media processing-related processes and functions; GPS/Navigation instructions 1568 to facilitate GPS and navigation-related processes, such as the processes described in reference to FIGS. 1-14; camera instructions 1570 to facilitate camera-related processes and functions; and instructions 1572 for implementing some or all of the features and processes described in reference to FIGS. 1-14.

Each of the above identified instructions and applications may correspond to a set of instructions for performing one or more functions described above. These instructions need not be implemented as separate software programs, procedures, or modules. Memory 1550 may include additional instructions or fewer instructions. Furthermore, various functions of the device may be implemented in hardware and/or in software, including in one or more signal processing and/or application specific integrated circuits.

### Example Operating Environment

FIG. 16 is a block diagram of an example operating environment 1600 for mobile devices having the architecture shown in FIG. 15. Mobile devices 1602a and 1602b can, for example, communicate over one or more wired and/or wireless networks 1610 in data communication. For example, a wireless network 1612, e.g., a cellular network, can communicate with a wide area network (WAN) 1614, such as the Internet, by use of a gateway 1616. Likewise, an access device 1618, such as an 802.11g wireless access point, can provide communication access to the wide area network 1614. Each of mobile devices 1602a and 1602b can be mobile device 102.

In some implementations, both voice and data communications can be established over wireless network 1612 and the access device 1618. For example, mobile device 1602a can place and receive phone calls (e.g., using voice over Internet Protocol (VoIP) protocols), send and receive e-mail messages (e.g., using Post Office Protocol 3 (POP3)), and retrieve electronic documents and/or streams, such as web pages, photographs, and videos, over wireless network 1612, gateway 1616, and wide area network 1614 (e.g., using Transmission Control Protocol/Internet Protocol (TCP/IP) or User Datagram Protocol (UDP)). Likewise, in some implementations, the mobile device 1602b can place and receive phone calls, send and receive e-mail messages, and retrieve electronic documents over the access device 1618 and the wide area network 1614. In some implementations, mobile device 1602a or 1602b can be physically connected to the access device 1618 using one or more cables and the access device 1618 can be a personal computer. In this configuration, mobile device 1602a or 1602b can be referred to as a “tethered” device.

Mobile devices 1602a and 1602b can also establish communications by other means. For example, wireless device 1602a can communicate with other wireless devices, e.g., other mobile devices, cell phones, etc., over the wireless network 1612. Likewise, mobile devices 1602a and 1602b can establish peer-to-peer communications 1620, e.g., a personal area network, by use of one or more communication subsystems, such as the Bluetooth™ communication devices. Other communication protocols and topologies can also be implemented.

The mobile device 1602a or 1602b can, for example, communicate with one or more services (e.g., navigation service 1630) over the one or more wired and/or wireless networks. Mobile device 1602a or 1602b can also access other data and content over the one or more wired and/or wireless networks. For example, content publishers, such as news sites, Really Simple Syndication (RSS) feeds, web sites, blogs, social networking sites, developer networks, etc., can be accessed by mobile device 1602a or 1602b. Such access can be provided by invocation of a web browsing function or application (e.g., a browser) in response to a user touching, for example, a Web object.

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with an author, the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

A number of implementations have been described. Nevertheless, it will be understood that various modifications may be made. The systems and techniques presented herein are also applicable to other electronic text such as electronic newspaper, electronic magazine, electronic documents etc. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method of determining a grid-cell size for estimating the location of a device operating in an environment having radio frequency (RF) signal sources, the method comprising:
dividing the environment into a grid including a number of grid-cells, each grid-cell having a first grid-cell size;
for each grid-cell containing one or more survey points:
determining a likelihood score based on a signal strength measured at the one or more survey points; and
contributing the signal strength measurement to a statistical model for the grid-cell, where the statistical model provides a total likelihood score for the grid-cell;
determining a total likelihood score for the grid from the total likelihood scores for the surveyed grid-cells; and
repeating the method for one or more additional grids, each additional grid including grid-cells having grid-cell sizes that are different than the first grid-cell size, where the method is performed by one or more hardware processors.

2. The method of claim 1, further comprising:
selecting one of the grid or additional grids for use in position estimation in the environment based on the total likelihood scores for the first grid and additional grids.

3. The method of claim 1, where the environment is an indoor location.

4. The method of claim 1, where the RF signal sources are wireless access points or beacons.

5. The method of claim 1, where at least one grid-cell is square shaped.

6. The method of claim 1, where the likelihood score is determined by a log likelihood function.

7. The method of claim 1, where the statistical model is a Rayleigh distribution or an approximation of a Rayleigh distribution.

8. The method of claim 2, where selecting one of the grid or additional grids for use in the location estimation, further comprises selecting the grid having a grid-cell size by searching for a grid-cell size that minimizes a likelihood function of grid-cell size.

9. The method of claim 1, further comprising:
providing feedback to a surveyor visually or through an audio output of the device while the environment is being surveyed.

10. The method of claim 1, where the likelihood score for at least one survey point is uniform or exponential across a range of signal strengths.

11. A system comprising:
one or more processors;
memory coupled to the one or more processors and configured to store instructions, which, when executed by the one or more processors, causes the one or more processors to perform operations comprising:
dividing the environment into a grid including a number of grid-cells, each grid-cell having a first grid-cell size;
for each grid-cell containing one or more survey points:
determining a likelihood score based on a signal strength measured at the one or more survey points; and
contributing the signal strength measurement to a statistical model for the grid-cell, where the statistical model provides a total likelihood score for the grid-cell;
determining a total likelihood score for the grid from the total likelihood scores for the surveyed grid-cells; and
repeating the method for one or more additional grids, each additional grid including grid-cells having grid-cell sizes that are different than the first grid-cell size.

12. The system of claim 11, the operations further comprising:
selecting one of the grid or additional grids for use in the location estimation of the device based on the total likelihood scores for the first grid and additional grids.

13. The system of claim 11, where the environment is an indoor location.

14. The system of claim 11, where the RF signal sources are wireless access points or beacons.

15. The system of claim 11, where at least one grid-cell is square shaped.

16. The system of claim 11, where the likelihood score is determined by a log likelihood function.

17. The system of claim 11, where the statistical model is a Ricean distribution or an approximation of a Ricean distribution.

18. The system of claim 12, where selecting one of the grid or additional grids for use in the location estimation, further comprises selecting the grid having a grid-cell size by searching for a grid size that minimizes a likelihood function of grid size.

19. The system of claim 11, the operations further comprising:
providing feedback to a surveyor visually or through an audio output of the device while the environment is being surveyed.

20. The system of claim 11, where the likelihood score for at least one survey point is uniform or exponential across a range of signal strengths.
